(19) United States
(12) Patent Application Publication
(10) Pub. No.: US 2022/0253146 A1
(43) Pub. Date: Aug. 11, 2022

(54) Combine Inputs from Different Devices to Control a Computing Device

(71) Applicant: Finch Technologies Ltd., Fish Bay (VG)

(72) Inventors: Viktor Vladimirovich Erivantcev, Ufa (RU); Alexey Ivanovich Kartashov, Moscow (RU); Gary Stuart Yamamoto, Sacramento, CA (US); Guzel Kausarevna Khurmatullina, Ufa (RU)

(21) Appl. No.: 17/576,785

(22) Filed: Jan. 14, 2022

Related U.S. Application Data
(60) Provisional application No. 63/147,297, filed on Feb. 9, 2021.

(51) Int. Cl. G06F 3/01; G02B 27/01; G02B 27/00

(52) U.S. Cl. CPC G06F 3/017; G02B 27/017; G02B 2027/014; G02B 27/0093; G02B 2027/0138; G06F 3/015

(57) ABSTRACT

A sensor manager for virtual reality, augmented reality, mixed reality, or extended reality, configured to: communicate with a plurality of input modules attached to different parts of a user; communicate, with an application that generates a virtual reality content presented to the user; determine a context of the application, including geometry data of objects in the virtual reality content with which the user is allowed to interact with, commands to operate the objects, and gestures usable to invoke the respective commands; process input data received from the input modules to recognize gestures performed by the user; and communicate with the application to invoke commands identified based on the context of the application and the gestures recognized from the input data.

### RELATED APPLICATIONS

The present application claims priority to Prov. U.S. Pat. App. Ser. No. 63/147,297 filed Feb. 9, 2021, the entire disclosures of which application are hereby incorporated herein by reference.

### TECHNICAL FIELD

At least some embodiments disclosed herein relate to human machine interfaces in general and more particularly, but not limited to, input techniques to control virtual reality (VR), augmented reality (AR), mixed reality (MR), and/or extended reality (XR).

### BACKGROUND

A computing device can present a computer generated content in the form of virtual reality (VR), augmented reality (AR), mixed reality (MR), and/or extended reality (XR).

Various input devices and/or output devices can be used to simplify the interaction between a user and the system of VR/AR/MR/XR.

For example, an optical module having an image sensor or digital camera can be used to determine the identity of a user based on recognition of the face of the user.

For example, an optical module can be used to track the eye gaze of the user, to track the emotion of the user based on the facial expression of the user, to image the surrounding area of the user, to detect the presence of other users and their emotions and/or movements.

For example, an optical module can be implemented via a digital camera and/or a Lidar (Light Detection and Ranging) through Simultaneous Localization and Mapping (SLAM).

Further, such a system VR/AR/MR/XR can include an audio input module, a neural/electromyography module, and/or an output module (e.g., a display or speaker).

Typically, each of the different types of techniques, devices or modules to generate inputs for the system of VR/AR/MR/XR can have its own disadvantages in some situations.

For example, the optical tracking of objects requires the objects to be positioned within the field of view (FOV) of an optical module. Data processing implemented for an optical module has a heavy computational workload.

For example, an audio input module sometimes can recognize input audio data incorrectly (e.g., a user wasn't heard well or was interrupted by other noises).

For example, signals received from a neural/electromyography module (e.g., implemented in a pair of glasses or another device) can be insufficient to recognize some input commands from a user.

For example, input data received from inertial measurement units (IMUs) require the attaching of the modules to the body parts of a user.

### BRIEF DESCRIPTION OF THE DRAWINGS

FIG. 1 shows a system to process inputs according to one embodiment.

FIG. 2 illustrates an example in which input techniques can be used according to some embodiments.

FIGS. 3 to 18 illustrate usages of gesture inputs from a motion input module in a system of FIG. 1 and/or in the example of FIG. 2.

FIG. 19 shows a computing device having a sensor manager according to one embodiment.

FIG. 20 shows a method to process inputs to control a VR/AR/MR/XR system according to one embodiment.

### DETAILED DESCRIPTION

At least some embodiments disclosed herein provide techniques to combine inputs from different modules, devices and/or techniques to reduce errors in processing inputs to a system of VR/AR/MR/XR.

For example, the techniques disclosed herein include unified combinations of inputs to the computing device of VR/AR/MR/XR while interacting with a controlled device in different context modes.

For example, the techniques disclosed herein include alternative input method where a device having IMUs can be replaced by another device that performs optical tracking and/or generates neural/electromyography input data.

For example, the techniques disclosed herein can use a management element in the VR/AR/MR/XR system to obtain, analyze and process input data, predict and provide an appropriate type of interface. The type of can be selected based on the internal, external and situational factors determined from the input data and/or historical habits of a user of the system.

For example, the techniques disclosed herein include methods to switch between available input devices or modules, and methods to combine input data received from the different input devices or modules.

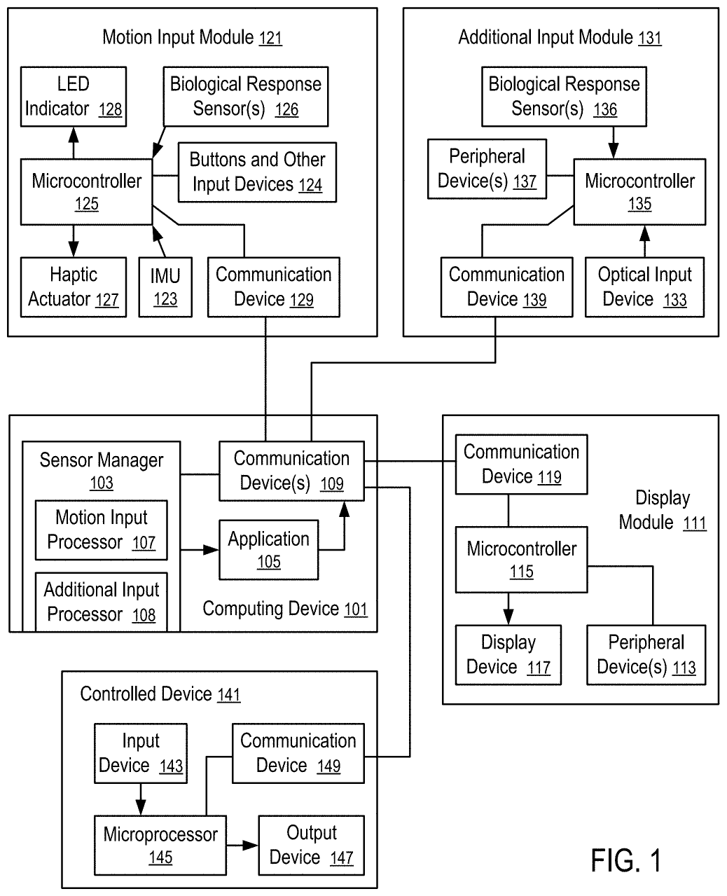

FIG. 1 shows a system to process inputs according to one embodiment.

In FIG. 1, the system has a main computing device 101, which can be referred to as a host. The computing device 101 has a sensor manager 103 configured to process input data generated by various input modules/devices, such as a motion input module 121, an additional input module 131, a display module 111, etc.

A motion input processor 107 is configured to track the position and/or orientation of a module having one or more inertial measurement units (123) and determine gesture input represented by the motion data of the module.

An additional input processor 108 can be configured to process the input data generated by the additional input module 131 that generates inputs using techniques different from the motion input module 121.

Optionally, multiple motion input modules 121 can be attached to different parts of a user (e.g., arms, hands, head, torso, legs, feet) to generate gesture inputs.

In FIG. 1, each input module (e.g., 121 or 131) is a device enclosed in a separate housing. Each of the input module (e.g., 121 or 131) has a communication device (e.g., 129 or 139) configured to provide their input data to the one or more communication devices 109 of the main computing device 101 that functions as a host for the input modules (e.g., 121 or 131).

In addition to having inertial measurement units (123) to measure the motion of the module 121, the motion input module 121 can optionally have components configured to generate inputs using components such as a biological response sensor 126, touch pads or panels, buttons and other input devices 124, and/or other peripheral devices (e.g., a microphone). Further, the motion input module 121 can have components configured to provide feedback to the user, such as a haptic actuator 127, an LED (Light-Emitting Diode) indicator 128, a speaker, etc.

The main computing device 101 processes the inputs from the input modules (e.g., 121, 131) to control a controlled device 141. For example, the computing device 101 can process the inputs from the input modules (e.g., 121, 131) to generate inputs of interest to the controlled device 141 and transmit the inputs via a wireless connection (or a wired connection) to the communication device 149 of the controlled device 141, such as a vehicle, a robot, an appliance, etc. The controlled device 141 can have a microprocessor 145 programmed via instructions to perform operations. In some instances, the control device 141 can be use without the computing device 101.

The controlled device 141 can be operated independent from the main computing device 101 and the input modules (e.g., 121, 131). For example, the controlled device 141 can have an input device 143 to receive inputs from a user, and an output device 147 to respond to the user. The inputs communicated to the communication device 149 of the controlled device 141 can provide an enhanced interface for the user to control the device 141.

The system of FIG. 1 can include a display module 111 to provide visual feedback of VR/AR/MR/XR to the user on a display device 117. The display module 111 has a communication device 119 connected to a communication device 109 of the main computing device 101 to receive output data (e.g., visual feedback) generated by the VR/AR/MR/XR application 105 running in the computing device 101.

The additional input module 131 can include an optical input device 133 to identify objects or persons and/or track their movements using an image sensor. Optionally, the additional input module 131 can include one or more inertial measurement units and/or configured in a way similar to the motion input module 121.

The input modules (e.g., 121, 131) can have biological response sensors (e.g., 126, 136). Some examples of input modules having biological response sensors (e.g., 126, 136) can be found in U.S. patent application Ser. No. 17/008,219, filed Aug. 31, 2020 and entitled “Track User Movements and Biological Responses in Generating Inputs For Computer Systems,” and U.S. Pat. App. Ser. No. 63/039,911, filed Jun. 16, 2020 and entitled “Device having an Antenna, a Touch Pad, and/or a Charging Pad to Control a Computing Device based on User Motions,” the entire disclosures of which applications are hereby incorporated herein by reference.

The input modules (e.g., 121, 131) and the display module 111 can have peripheral devices (e.g., 137, 113) such as buttons and other input devices 124, a touch pad, an LED indicator 128, a haptic actuator 127, etc. The modules (e.g., 111, 121, 131) can have microcontrollers (e.g., 115, 125, 135) to control their operations in generating and communicating input data to the main computing device 101.

The communication devices (e.g., 109, 119, 129, 139, 149) in the system of FIG. 1 can be connected via wired and/or wireless connections. Thus, the communication devices (e.g., 109, 129, 139) are not limited to specific implementations.

In the system of FIG. 1, input data can be generated in the input modules (e.g., 121, 131) and the display module 111 using various techniques, such as an inertial measurement unit 123, an optical input device 133, a button 124, or another input device (e.g., a touch pad, a touch panel, a piezoelectric transducer or sensor).

Optionally, a motion input module 121 is configured to use its microcontroller 125 to pre-process motion data generated by its inertial measurement units 123 (e.g., accelerometer, gyroscope, magnetometer). The pre-processing can include calibration to output motion data relative to a reference system based on a calibration position and/or orientation of the user. Examples of the calibrations and/or pre-processing can be found in U.S. Pat. No. 10,705,113, issued on Jul. 7, 2020 and entitled “Calibration of Inertial Measurement Units Attached to Arms of a User to Generate Inputs for Computer Systems,” U.S. Pat. No. 10,521,011, issued on Dec. 31, 2019 and entitled “Calibration of Inertial Measurement Units Attached to Arms of a User and to a Head Mounted Device,” and U.S. patent application Ser. No. 16/576,661, filed Sep. 19, 2019 and entitled “Calibration of Inertial Measurement Units in Alignment with a Skeleton Model to Control a Computer System based on Determination of Orientation of an Inertial Measurement Unit from an Image of a Portion of a User,” the entire disclosures of which patents or applications are incorporated herein by reference.

In addition to motion input generated using the inertial measurement units 123 and optical input devices 133 of the input modules (e.g., 121, 131), the modules (e.g., 121, 131, 111) can generate other inputs in the form of audio inputs, video inputs, neural/electrical inputs, biological response inputs from the user and the environment in which the user is positioned or located.

Raw or pre-processed input data of various different types can be transferred to the main computing device 101 via the communication devices (e.g., 109, 119, 129, 139).

The main computing device 101 receives input data from the modules 111, 121, and/or 131, processes the received data using the sensor manager 103 (e.g., implemented via programmed instructions running in one or more microprocessors) to power a user interface implemented via a ARNR/XR/MR application, which generates output data to control the controlled device 141 and sends the visual information about current status of the ARNR/XR/MR system for presentation on the display device 117 of the display module 111.

For example, ARNR/XR/MR glasses can be used to implement the main computing device 101, the additional input module 131, the display module 111, and/or the controlled device 141.

For example, the additional input module 131 can be a part of smart glasses used by a user as the display module 111.

For example, the optical input device 133 configured on smart glasses can be to track the eye gaze direction of the user, the facial emotional state of the user, and/or the images of the area surrounding the user.

For example, a speaker or a microphone in the peripheral devices (e.g., 113, 137) of the smart glasses can be used to generate an audio stream for capturing voice commands from the user.

For example, a fingerprint scanner and/or a retinal scanner or other type of scanner configured on the smart glasses can be used to determine the identity of a user.

For example, biological response sensors 136, buttons, force sensors, touch pads or panels, and/or other types of input devices configured on smart glasses can be used to obtain inputs from a user and the surrounding area of the user.

The smart glasses can be used to implement the display module 111 and/or provide the display device 117. Output data of the VR/AR/MR/XR application 105 can be presented on the display/displays of the glasses.

In some implementations, the glasses can be also be used to implement the main computing device 101 to process inputs from the inertial measurement units 123, the buttons 124, biological response sensors 126, and/or other peripheral devices (e.g., 137, 113).

In some implementations, the glasses can be a controlled device 141 where the display on the glasses is controlled by the output of the application 105.

Thus, some of the devices (e.g., 101, 141) and/or modules (e.g., 111 and 131) can be combined and implemented in a combined device with a shared housing structure (e.g., in a pair of smart glasses for AR/VR/XR/MR).

The system of FIG. 1 can implement unified combinations of inputs to the main computing device 101 while the user is interacting with the controlled device 141 in different context modes.

To interact with the AR/VR/MR/XR system of FIG. 1 and its user interfaces a user can use different input combinations to provide commands to the system. The motion input module 121 can be combined with the additional input modules 131 of different types to generate commands to the system.

For example, the input commands provided via the motion input module 121 and its peripherals (e.g., buttons and other input devices 124, biological response sensors 126) can be combined with data received from the additional input module 131 to simplify the interaction with the AR/VR/MR/XR application 105 running in the main computing device 101.

For example, the motion input module 121 can have a touch pad usable to generate an input of swipe gesture, such as swipe left, swipe right, swipe up, swipe down, or an input of tap gesture, such as single tap, double tap, long tap, etc.

For example, the button 124 (or a force sensor, or a touch pad) of the motion input module 121 can be used to generate an input of press gesture, such as press, long press, etc.

For example, the inertial measurement units 123 of the motion input module 121 can be used to generate orientation vectors of the module 121, the position coordinates of the module 121, a motion-based gesture, etc.

For example, the biological response sensors 126 can generate inputs such as those described in U.S. patent application Ser. No. 17/008,219, filed Aug. 31, 2020 and entitled “Track User Movements and Biological Responses in Generating Inputs for Computer Systems,” and U.S. Pat. App. Ser. No. 63/039,911, filed Jun. 16, 2020 and entitled “Device having an Antenna, a Touch Pad, and/or a Charging Pad to Control a Computing Device based on User Motions,” the entire disclosures of which applications are hereby incorporated herein by reference.

For example, the optical input device 133 of the additional input module 131 can be used to generate an input of eye gaze direction vector, an input of user identification (e.g., based on fingerprint, or face recognition), an input of emotional state of the user, etc.

For example, the optical input device 133 of the additional input module 131 can be used to determine the position and/or orientation data of a body part (e.g., head, neck, shoulders, forearms, wrists, palms, fingers, torso) of the user relative to a reference object (e.g., a head mount display, smart glasses), the position of the user relative to nearby objects (e.g., through SLAM tracking), to determine the position of nearby objects with which the user is interacting or can interact, emotional states of one or more other persons near the user.

For example, an audio input device in the additional input module 131 can be used to generate an audio stream that can contain voice inputs from a user.

For example, an electromyography sensor device of the additional input module 131 can be used to generate neural/muscular activity inputs of the user. Muscular activity data can be used to identify the position/orientation of certain body parts of the user, which can be provided in the form of orientation vectors and/or the position coordinates. Neural activity data can be measured based on electrical impulses of the brain of the user.

For example, a proximity sensor of the additional input module 131 can be used to detect an object or person approaching the user

While interacting with the VR/AR/MR/XR application 105 a user can activate the following context modes:

1. General (used in the main menu or the system menu)

2. Notification/Alert

3. Typing/text editing

4. Interaction within an activated application 105

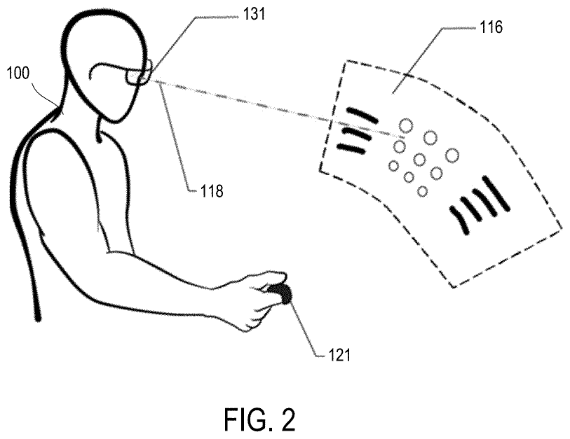

To illustrate the interaction facilitated by modules 111, 121 and 131 and the computing device 101, an AR example illustrated in FIG. 2 is described.

FIG. 2 illustrates an example in which input techniques can be used according to some embodiments.

In the example of FIG. 2, the display generated by the application 105 is projected onto the view of the surrounding area of the user via AR glasses (e.g., display module 111) worn by the user. The motion input module 121 is configured as a handheld device.

The eye gaze direction vector 118 determined by the optical input device 133 embedded into the AR glasses is illustrated in FIG. 2 as a line from the eyes of the user to the display screen 116 projected by the AR glasses on the field of view of the surrounding area in front of the user.

Depending on the context mode activated by the user, the inputs from the motion input module 121 and the additional input module 131 can be combined and interpreted differently by the sensor manager 103 of the main computing device 101.

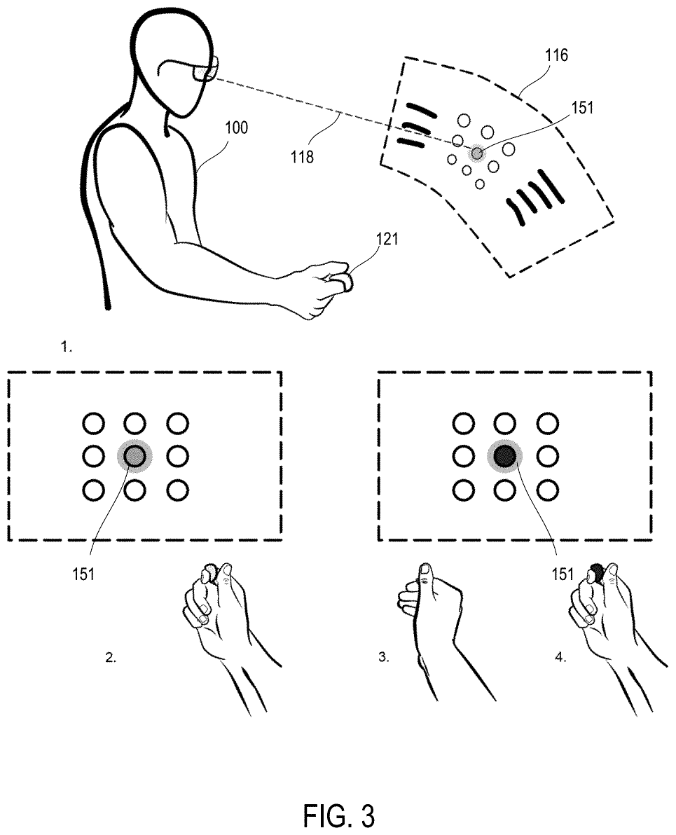

FIG. 3 illustrates the use of an eye gaze direction vector 118 determined using an additional input module 131 and a tap gesture generated using a motion input module 121 to select and activate a menu item according to one embodiment.

When the application 105 enters a general context of interacting with menus, the user can interact with a set of menu items presented on the AR display 116. In such a context, the sensor manager 103 and/or the application 105 can use the eye gaze direction vector 118 to select an item 151 from the set of menu items in the display and use the tap input from the motion input module 121 to active the selected menu item 151.

To indicate the selection of the item 151, the appearance of the selected item 151 can be changed (e.g., to be highlighted, to have a changed color or size, to be animated, etc.).

Thus, the system of FIG. 1 allows the user 100 to select an item 151 by looking at the item presented via the smart glasses and confirm the selection by tapping a touch pad or panel of the handheld motion input module 121.

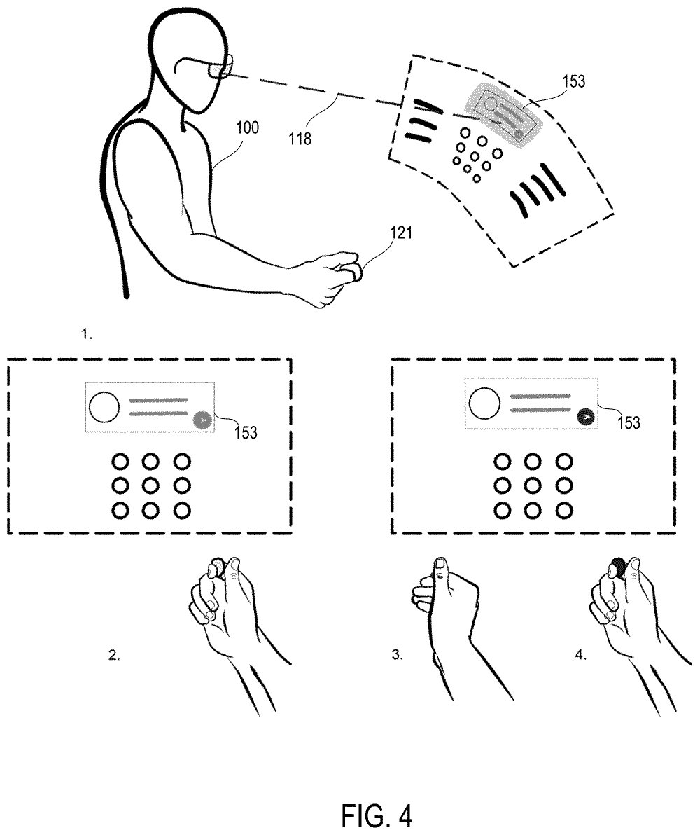

FIG. 4 illustrates the use of an eye gaze direction vector 118 determined using an additional input module 131 and a tap gesture generated using a motion input module 121 to select a window 153 and apply a command to operate the window 153 according to one embodiment.

When the application 105 enters a context of notification or alert, a pop-up window appears for interaction with the user. For example, the window 153 pops up to provide a notification or message; and in such a context, the sensor manager 103 and/or the application 105 can adjust the use of the eye gaze direction vector 118 to determine whether the user 100 is using the eye gaze direction vector 118 to select the window 153. If the user looks at the pop-up window 153, the display of the pop-up window 153 can be modified to indicate that the window is being highlighted. For example, the adjustment of the display of the pop-up window 153 can be a change in size, and/or color, and/or an animation. The user can confirm the opening of the window 153 by a tap gesture generated using the handheld motion input module 121.

Different commands can be associated with different gesture inputs generated by the handheld motion input module 121. For example, a swipe left gesture can be used to open the window 153; a swipe right gesture can be used to dismiss the pop-up window 153; etc.

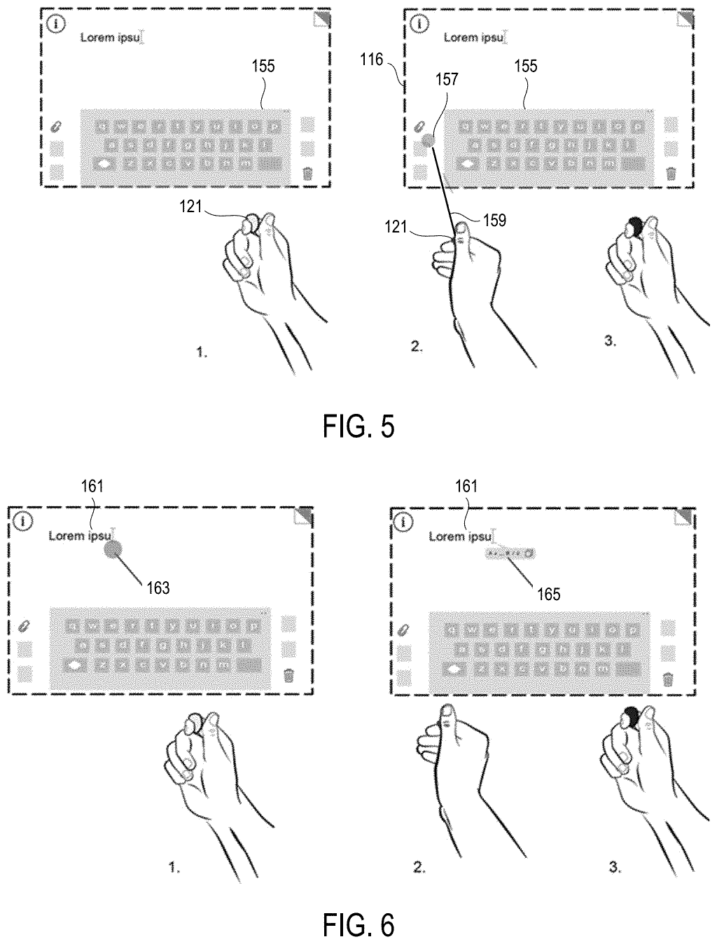

FIG. 5 illustrates the use of an eye gaze direction vector 118 determined using an additional input module 131 and a tap gesture generated using a motion input module 121 to select and activate/deactivate an editing tool.

When the application 105 enters a typing or text editing mode, the system can provide an editing tool, such as a navigation tool 157 (e.g., a virtual laser pointer) that can be used by the user to point at objects in the text editor 155.

When the navigation tool 157 is activated, the position and/or orientation of the handheld motion input module 121 can be used to model the virtual laser pointer in shining light from the module 121 to the AR display 116, as illustrated by the line 159.

FIG. 6 illustrates the use of an eye gaze direction vector 118 determined using an additional input module 131 and a tap gesture generated using a motion input module 121 to invoke or dismiss a text editor tool 165.

For example, when the eye gaze direction vector 118 is directed at a field 161 that contains text, the user can generate a tap gesture using the handheld motion input module 121 to activate the editing of the text field.

Optionally, an indicator 163 can be presented to indicate the location that is currently being pointed at by the eye gaze direction vector 118. Alternatively, the displayed text field selected via the eye gaze direction vector 118 can be changed (e.g., via highlighting, color or size change, animation).

For example, when a predefined gesture generated is generated using the handheld motion input module 121 while the eye gaze direction vector 118 points at the text field 161, a pop-up text editor tool 165 can be presented to allow the user to select a tool to edit properties of text in the field 161, such as font, size, color, etc.

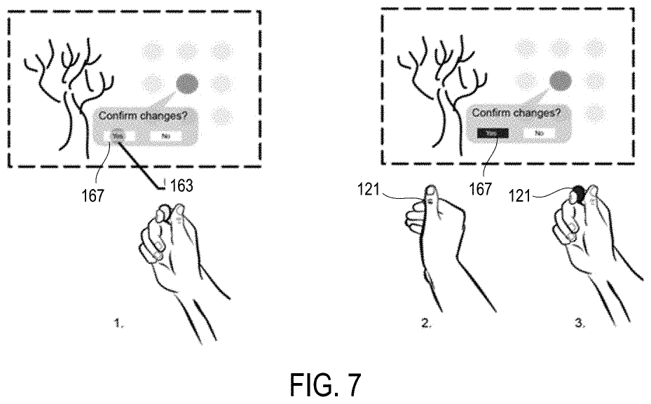

FIG. 7 illustrates the use of an eye gaze direction vector 118 determined using an additional input module 131 and a tap gesture generated using a motion input module 121 for interaction within the context of an active application 105.

When the system is in the context of an active application 105, the user can use a tap gesture generated using the motion input module 121 as a command to confirm an action selected using the eye gaze direction vector 118.

For example, when the user eye gaze is at a field of a button 167, the tap gesture generated on the handheld motion input module 121 causes the confirmation of the activation of the button 167.

In another example, while watching a video content in the video application 105 configured in AR display 116, the user can select a play/pause icon using a gaze direction, laser pointer or other input tool, can activate the default action of the selected icon by tapping the touch pad/panel on the handheld motion input module 121.

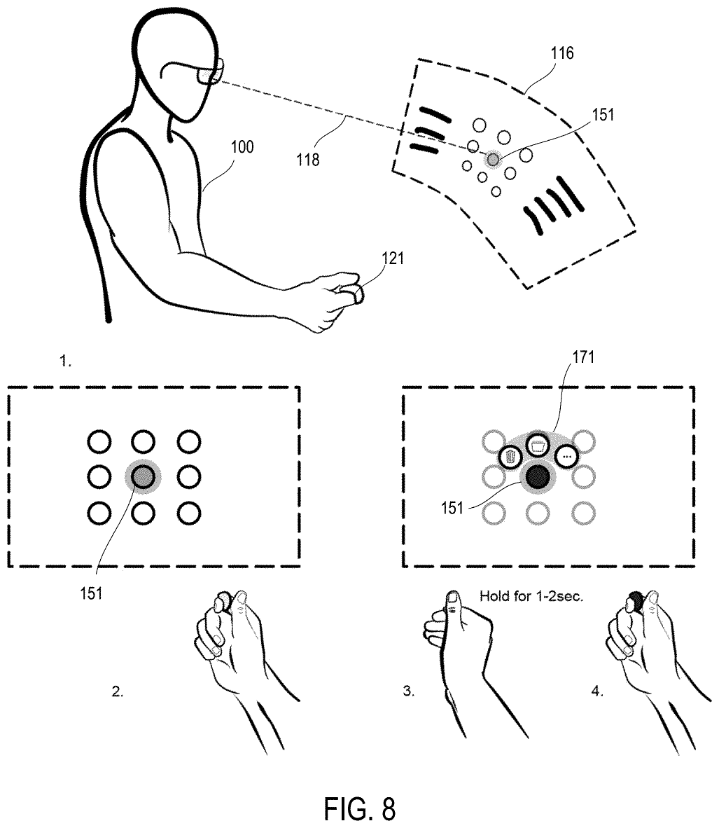

FIG. 8 illustrates the use of an eye gaze direction vector 118 determined using an additional input module 131 and a long tap gesture generated using a motion input module 121 to request additional options of a menu item according to one embodiment.

A long tap gesture can be generated by a finger of the user touching a touch pad of the handheld motion input module 121, placing on the finger on the touch pad for a period longer than a threshold (e.g., one or two seconds), and moving the finger away from the touch pad to end the touch. When the finger remains on the touch pad for a period shorter than the threshold, the gesture is considered a tap but not a long tap.

In FIG. 8, the user 100 looks at an icon item 151 in the AR display 116 (e.g., that includes a main menu having a plurality of icon items). The eye gaze direction vector 118 is used to select the item 151 in a way similar to the example shown in FIG. 3. The item 151 selected by the eye gaze direction vector 118 can be highlighted via color, size, animation, etc. To request available options related to the item 151, the user 100 can generate a long tap gesture using the handheld motion input module 121. In response to the long tap gesture, the system presents the options 171.

In alternative embodiments, the long tap gesture (or a gesture of type made using the handheld motion input module 121) can be used to active other predefined actions/commands associated with the selected item 151. For example, the long tap gesture (or another gesture) can be used to invoke a command of delete, move, open, or close, etc.

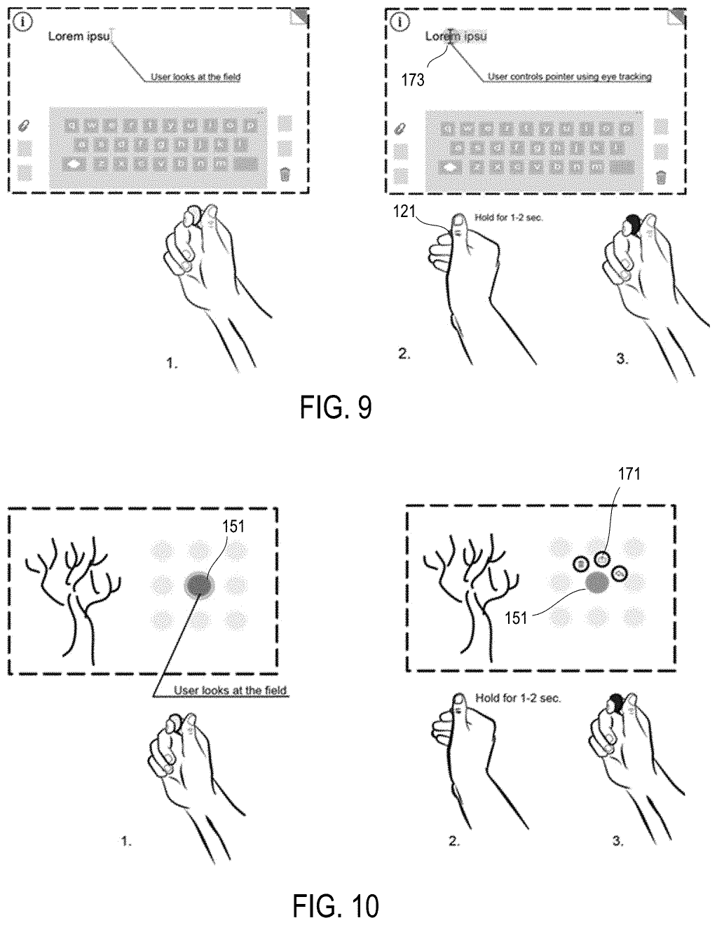

In a context of notification or alert, or a context of typing or text editing, the combination of the eye gaze direction vector 118 and a long tap gesture can be used to highlight a fragment of text, as illustrated in FIG. 9.

For example, during the period of the finger touching the touch pad of the handheld motion input module in making the long tap, the user can move the eye gaze direction vector 118 to adjust the position of the point 173 identified by the eye gaze. A portion of the text is selected using the position point 173 (e.g., from the end of the text field, from the beginning of the text field, or from a position selected via a previous long tap gesture).

A long tap gesture can be used to resize a selected object. For example, after a virtual keyboard is activated and presented in the AR display 116, the user can look at a corner (e.g., the top right corner) of the virtual keyboard to make a selection using the eye gaze direction vector 118. While the selected corner is being selected via the eye gaze direction vector 118, the user can make a long tap gesture using the handheld motion input module 121. During the toughing period of the long tap, the user can move the eye gaze to scale the virtual keyboard such that the selected corner of the resized virtual keyboard is at the location identified by the new gaze point.

Similarly, a long tap can be used to move the virtual keyboard in a way similar to a drag and drop operation in a graphical user interface.

In one embodiment, a combination of a long tap gesture and the movement of the eye gaze direction vector 118 during the touch period of the long tap is used to implement a drag operation in the AR display 116. The ending position of the drag operation is determined from the ending position of the eye gaze just before the touch ends (e.g., the finger previously touching the touch pad leaves the touch pad).

In one embodiment, the user can perform a pinch gesture using two fingers. The pinch can be detected via an optical input device of the additional input module 131, or via the touch of two fingers on a touch pad/panel of the handheld motion input module 121, or via the detection of the movement of the motion input module 121 configured as a ring worn on a finger of the user 100 (e.g., an index finger), or via the movements of two motion input modules 121 worn by the user 100.

When interacting within a specific AR application 105, the user can use the long tap gesture as a command. For example, the command can be configured to activate or show additional options of a selected tool, as illustrated in FIG. 10 (in a way similar to the request for available options illustrated in FIG. 8).

In some embodiments, the motion input module 121 includes a force sensor (or a button 124) that can detect a press gesture. When such a press gesture is detected, it can be interpreted in the system of FIG. 1 as a replacement of a tap gesture discussed above. Further, when a time period where the force sensor (or a button 124) is being pressed is longer than a threshold, the press gesture can be interpreted as a long press gesture, which can be a replacement of a long tap gesture discussed above.

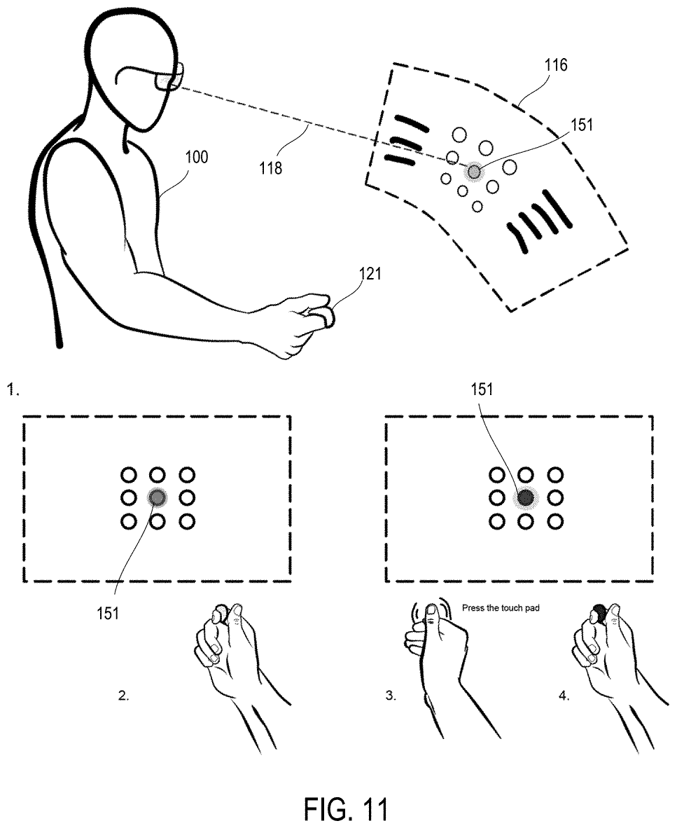

FIG. 11 illustrates the activation of a selected item through a press gesture, which is similar to the activation of a selected item through a tap gesture illustrated in FIG. 3.

For example, a user can use the eye gaze direction vector 118 to select a link in a browser application presented in the AR display 116 and perform a press gesture to open the selected link.

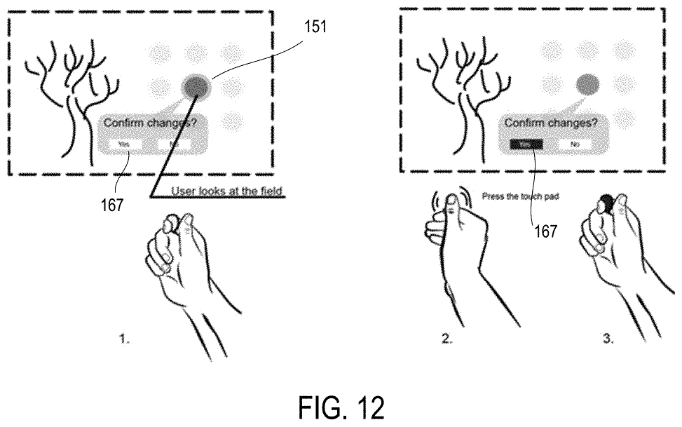

FIG. 12 illustrates the use of a press gesture to activate a default button 167 in a pop-up window for an item 151 selected based on the eye gaze direction vector 118.

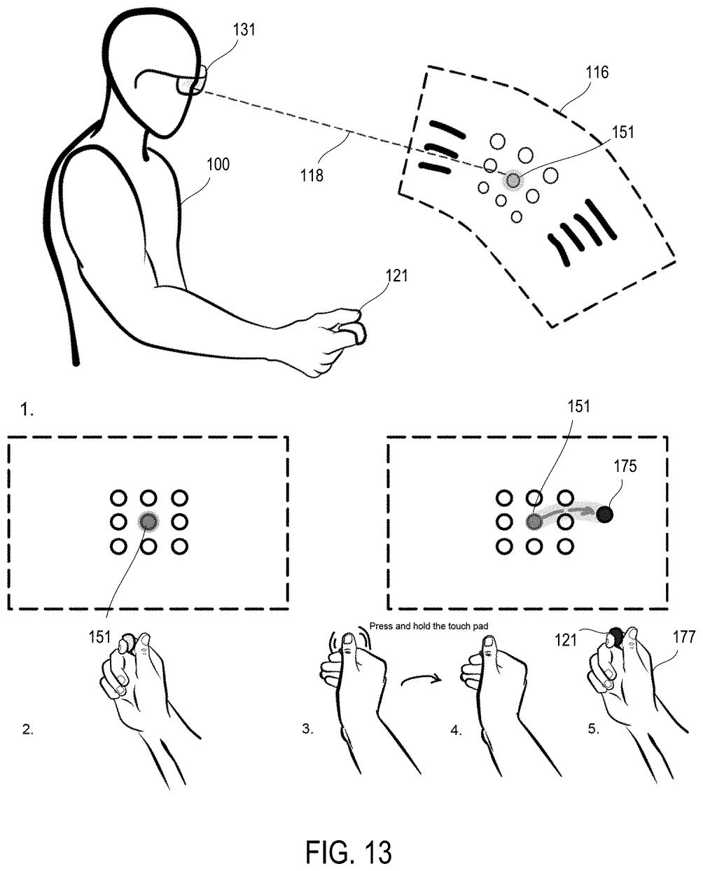

FIG. 13 illustrates the drag of a selected icon item 151 via a long press to a destination location 175. The path of the icon item 151 being dragged can be based on, while the force sensor (or the button 124) of the motion input module 121 is being pressed, the movement of the eye gaze direction vector 118, the movement of the motion input module 121 determined by its inertial measurement units 123, or the movement of the hand 177 of the user 100 using the optical input device 133 of the additional input module 131.

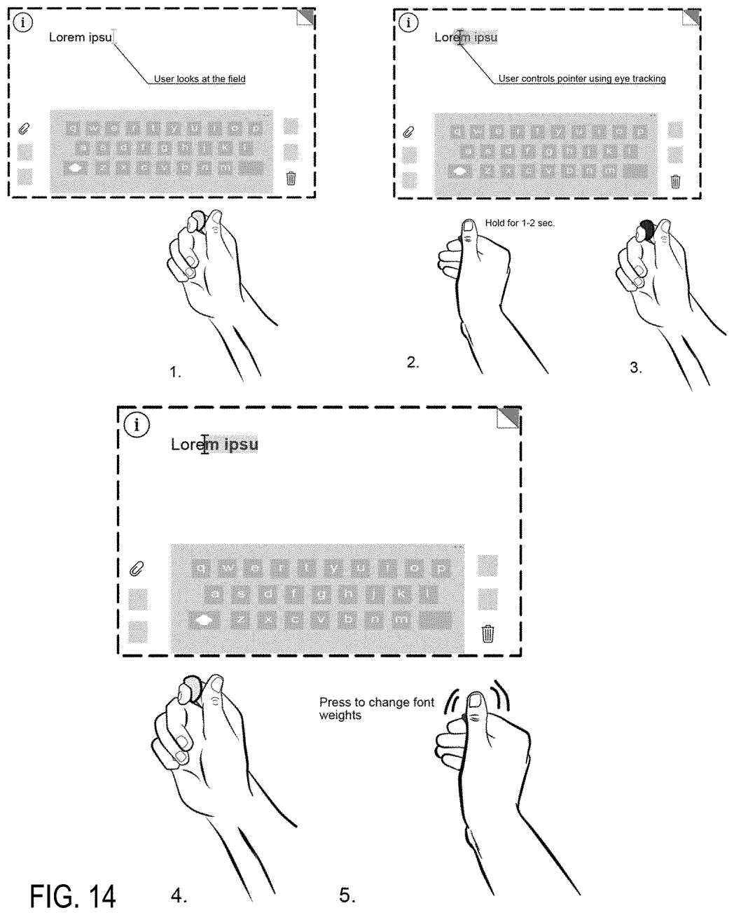

In a context of notification or alert, or in the context of typing or editing text, a long press gesture can be used to select a text segment in a text field for editing (e.g., to change font, color or size, or to copy, delete, or paste over the selected text). FIG. 14 illustrates the text selection performed using a long press gesture, which is similar to the text selection performed using a long tap gesture in FIG. 9.

In FIG. 14, after the selection of a text segment, a further gesture can be used to apply a change to the selected text segment. for example, a further press gesture can be used to change the font weight of the selected text.

In a context of interacting within an active application 105, a long press gesture can be used to drag an item (e.g., an icon, a window, an object), or a portion of the item (e.g., for resizing, repositioning, etc.).

The user can use a finger on a touch pad of the motion input module 121 to perform a swipe right gesture by touching the finger on the touch pad, and moving the touching point to the right while maintaining the contact between the finger and the touch pad, and then moving the finger away from the touch pad.

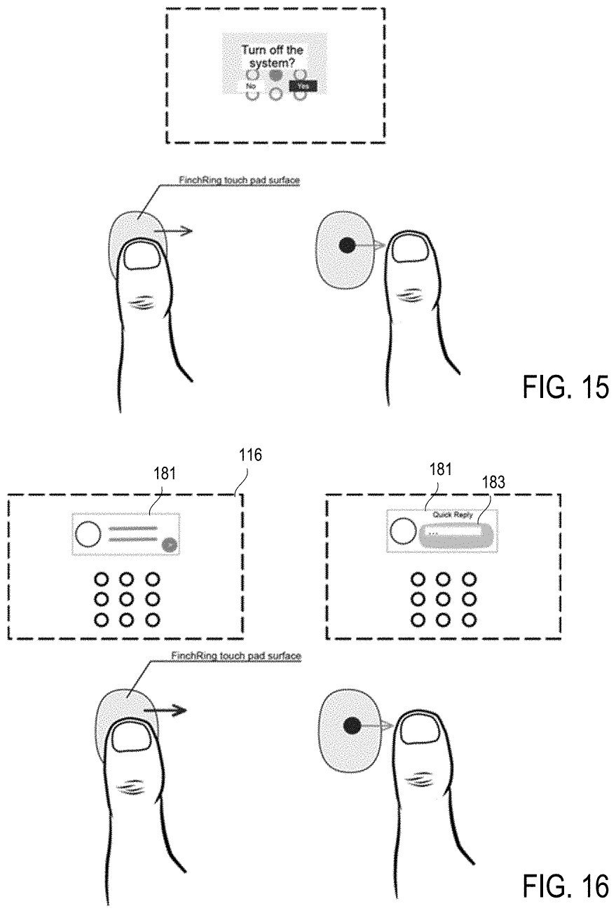

The swipe right gesture detected on the touch pad can be used in combination with the activation of a functional button (e.g., configured on smart glasses worn on the user, or configured on the main computing device 101, or the additional input module 131, or another motion input module). When in a context of menu operations, the combination can be interpreted by the sensor manager 103 as a command to turn off the AR system (e.g., activate a sleep mode), as illustrated in FIG. 15.

When in the context of notification or alert, a swipe right gesture can be used to activate a predefined mode (e.g., “fast response” or “quick reply”) for interacting with the notification or alert, as illustrated in FIG. 16.

For example, when the AR display shows a pop-up window 181 to deliver a message, notification, or alert, the user can select the pop-up window 181 using the eye gaze direction vector 118 by looking at the window 181 and perform a swipe right gesture on the touch pad of the handheld motion input module 121. The combination causes the pop-up window 181 to replace the content of the message, notification or alert with a user interface 183 to generate a quick reply to the message, notification or alert. Alternatively, the combination hides the notification window 181 and presents a reply window to address the notification.

In some implementations, a swipe right gesture is detected based at least in part on the motion of the motion input module 121. For example, a short movement of the motion input module 121 to the right can be interpreted by the sensor manager 103 as a swipe right gesture.

For example, a short movement to the right while the touch pad of the motion input module 121 being touched (or a button 124 being pressed down) can be interpreted by the sensor manager 103 as a swipe right gesture.

For example, a short, quick movement of the motion input module 121 to the right followed by a return to an initial position can be interpreted by the sensor manager 103 as a swipe right gesture.

A swipe left gesture can be detected in a similar way and used to activate a context-dependent command or function. For example, in a main menu of the AR system, a swipe left gesture can be used to request the display of a list of available applications.

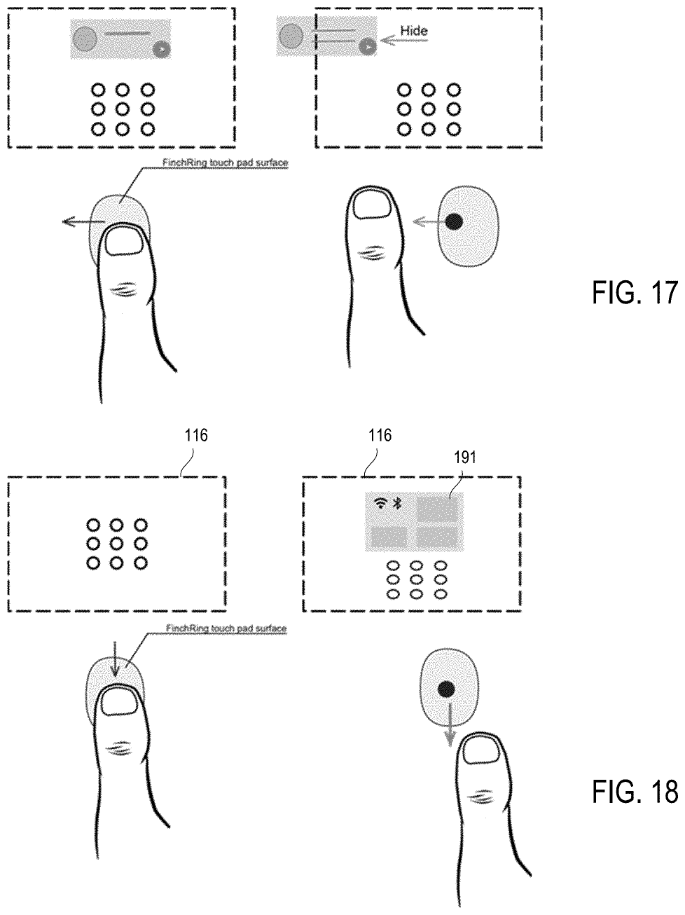

For example, in a context of notification or alert, a swipe left gesture can be used to request the system to hide the notification window (e.g., selected via the eye gaze direction vector 118), as illustrated in FIG. 17.

Similar, in the context of typing or text editing, a swipe left gesture can be used to request the system to hide a selected tool, element or object. For example, the user can look at the upper right/left or the lower right/left corner of the virtual keyboard (the corner can be set on the system or application level) and perform a swipe left gesture to hide the virtual keyboard.

In the context of an active application, a swipe left gesture can be used to close the active application. For example, the user can look at the upper right corner of an application presented in the AR display 116 and perform a swipe left gesture to close the application.

A swipe down gesture can be performed and detected in a way similar to a swipe left gesture or a swipe right gesture.

For example, in the main menu of the AR system, the swipe down gesture can be used to request the system to present a console 191 (or a list of system tools), as illustrated in FIG. 18. The system console 191 can be configured to show information and/or status of the AR system, such as time/date, volume level, screen brightness, wireless connection, etc.

For example, in a context of notification or alert, or a context of typing or text editing, a swipe down gesture can be used to create a new paragraph.

For example, after a text fragment is selected, a swipe down gesture can be used to request the copying of the selected text to the clipboard of the system.

In the context of an active application, a swipe down gesture can be used to request the system to hide the active application from the AR display 116.

A swipe up gesture can be performed and detected in a way similar to a swipe down gesture.

For example, in the main menu of the AR system, a swipe up gesture can be used to request the system to hide the console 191 from the AR display 116.

If a text fragment is selected, a swipe up gesture can be used to request the system to cut the selected text fragment and copy it to the clipboard of the system.

The movements of the motion input module 121 measured using its inertial measurement units 123 can be projected to identify movements to the left, right, up, or down relative to the user 100. The movement gesture determined based on the inertial measurement units 123 of the motion input module 121 can be used to control the AR system.

For example, a gesture of moving to the left or right can be used in the context of menu operations to increase or decrease a setting associated with a control element (e.g., a brightness control, a volume control, etc.). The control element can be selected via the eye gaze direction vector 118, or another method, or as a default control element in a context of the menu system and pre-associated with the gesture input of moving to the left or right.

For example, a gesture of moving to the left or right (or, to the up or down) can be used in the context of typing or text editing to move a scroll bar. The scroll bar can be selected via the eye gaze direction vector 118, or another method, or as a default control element in a context and pre-associated with the gesture input of moving to the left or right.

Similarly, the gesture of moving to the left or right (or, to the up or down) can be used in the context of an active application 105 to adjust a control of the application 105, such as the analogue setting of brightness or volume of the application 105. Such gestures can be pre-associated with the control of the application 105 when the application 105 is active, or selected via the eye gaze direction vector 118, or another method.

The movements of the motion input module 121 measured using its inertial measurement units 123 can be projected to identify a clockwise/anticlockwise rotation in front of the user 100. The movement gesture of clockwise rotation or anticlockwise rotation can be determined based on the inertial measurement units 123 of the motion input module 121 and used to control the AR system.

For example, in the context of typing or text editing, a gesture of clockwise rotation can be used to set a selected segment of text in italic font; and a gesture of anticlockwise rotation can be used to set the selected segment of text in non-italic font.

For example, in the context of an active application 105, the gesture of clockwise rotation or counterclockwise rotation can be used to adjust a control of the application 105, such as the brightness or volume of the application 105.

From the movements measured by the inertial measurement units 123, the sensor manager 103 can determine whether the user has performed a grab gesture, a pinch gesture, etc. For example, an artificial neural network can be trained to classify whether the input of movement data contains a pattern representative of a gesture and if so, the classification of the gesture. A gesture identified from the movement data can be used to control the AR system (e.g., use a grab gesture to perform an operation of drag, use a pinch gesture to active an operation to scale an object, etc.).

Some of the gestures discussed above are detected using the motion input module 121 and/or its inertial measurement units 123. Optionally, such gestures can be detected using the additional input module 131 and/or other sensors. Thus, the operations corresponding to the gestures can be performed without the motion input module 121 and/or its inertial measurement units 123.

For example, a gesture of the user can be detected using the optical input device 133 of the additional input module 131.

For example, a gesture of the user can be detected based on neural/electromyography data generated using a peripheral device 137 or 113 outside of the motion input module 121, or other input devices 124 of the motion input module 121.

For example, from the images captured by the optical input device 133 (or data from a neural/electromyography sensor), the system can detect the gesture of the user 100 touching the middle phalange of the index finger by the thumb for a tap, long tap, press, long press gesture, as if the motion input module 121 having a touch pad were worn on the middle phalange of the index finger.

In the system of FIG. 2, a sensor manager 103 is configured to obtain, analyze and process input data received from the input modules (e.g., 121, 131) to determine the internal, external and situational factors that affect the user and their environment.

The sensor manager 103 is a part of the main computing device 101 (e.g., referred to as a host of the input modules 121, 131) of the AR system.

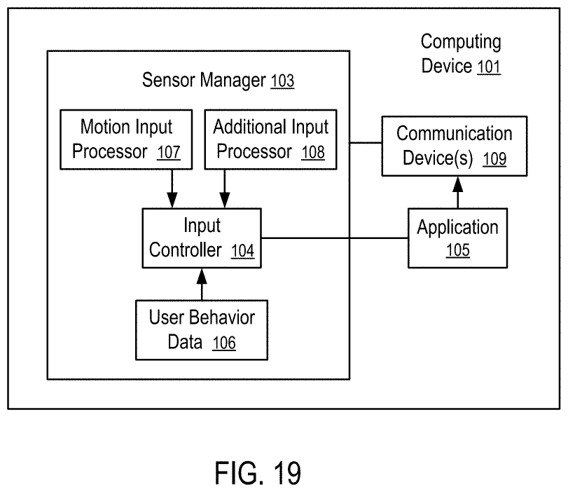

FIG. 19 shows a computing device 101 having a sensor manager 103 according to one embodiment. For example, the sensor manager 103 of FIG. 19 can be used in the computing device 101 of FIG. 1.

The sensor manager 103 is configured to recognize gesture inputs from the input processors 107 and 108 and generate control commands for the VR/AR/MR/XR application 105.

For example, the motion input processor 107 is configured to convert the motion data from the motion input module 121 into a reference system relative to the user 100. The input controller 104 of the sensor manager 103 can determine a motion gesture of the user 100 based on the motion input from the motion input processor 107 and an artificial neural network, trained via machine learning, to detect whether the motion data contains a gesture of interest, and a classification of any detected gestures. Optionally, the input controller 104 can further map the detected gestures to commands in the application 105 according to the current context of the application 105.

To process the inputs from the input processors 107 and 108, the input controller 104 can receive inputs from the application 105 specifying the virtual environment/objects in the current context of the application 105. For example, the application 105 can specify the geometries of virtual objects and their positions and orientations in the application 105. The virtual objects can include control elements (e.g., icons, virtual keyboard, editing tools, control points) and commands for their operations. The input controller 104 can correlate the position/orientation inputs (e.g., eye gaze direction vector 118, gesture motion to left, right, up and down) from the input processors 107 and 108 and corresponding positions, orientations and geometry of the control elements in the virtual world in the AR/VR/MR/XR display 116 to identify the selections of control elements identified by the inputs and the corresponding commands invoked by the control elements. The input controller 104 provides the identify commands of the relevant control elements to the application 105 in response to the gestures identified from inputs from the input processors 107 and 108.

Optionally, the sensor manager 103 can store user behavior data 106 that indicates the patterns of usage of control elements and their correlation with patterns of inputs from the input processors 108. The input patterns can be recognized as gestures for invoking the commands of the control elements.

Optionally, the input controller 104 can use the user behavior data 106 to predict the operations the user intends to perform, in view of the current inputs from the processors 107 and 108. Based on the prediction, the input controller 104 can instruct the application 105 to generate virtual objects/interfaces to simplify the user interaction required to perform the predicted operations.

For example, when the input controller 104 predicts that the user is going to edit text, the input controller 104 can instruct the application 105 to present a virtual keyboard and/or enter a context of typing or text editing. If the user dismisses the virtual keyboard without using it, a record is added to the user behavior data 106 to reduce the association between the use of a virtual keyboard and the input pattern observed prior to the presentation of the virtual keyboard. The record can be used in machine learning to improve the accuracy of a future prediction. Similarly, if the user uses the virtual keyboard, a corresponding record can be added to the user behavior data 106.

In some implementations, the records indicative of the user behavior is stored and used in machine learning to generate a predictive model (e.g., using an artificial neural network). The user behavior data 106 includes a trained model of the artificial neural network. The training of the artificial neural network can be performed in the computing device 101 or in a remote server.

The input controller 104 is configured to detect gesture inputs based on the availability of input data from various input modules (e.g., 121, 131) configured on different parts of the user 100, the availability of input data from optional peripheral devices (e.g., 137, 113, and/or buttons and other input devices 124, biological response sensors 126, 136) in the modules (e.g., 121, 131, 111), the accuracy estimation of the available input data, and the context of the ARA/R/MR/XR application 105.

Gestures of a particular type (e.g., a gesture of swipe, press, tap, long tap, long press, grab, or pinch) can be detected using multiple methods based on inputs from one or more modules and one or more sensors. When there are opportunities to detect a gesture of the type using multiple ways, the input controller 104 can priority the methods to select a method that provides reliable result and/or uses less resources (e.g., computing power, energy, memory).

Optionally, when the application is in a particular context, the input controller 104 can identify a set of gesture inputs that are relevant in the context and ignore input data relevant to the gesture inputs.

Optionally, when input data from a sensor or module is not used in a context, the input controller 104 can instruct the corresponding module to pause transmission of the corresponding input data to the computing device 101 and/or pause the generation of such input data to preserve resources.

The input controller 104 is configured to select an input method and/or selectively active or deactivate a module or sensor based on programmed logic flow, or using a predictive model trained through machine learning.

In general, the input controller 104 of the computing device 101 can different data from different sources to detect gesture inputs in multiple ways. The input data can include measured biometric and physical parameters of the user, such as heart rate, pulse waves (e.g., measured using optical heart rate sensor/photoplethysmography sensor configured one or more input modules), temperature of the user (e.g., measured using a thermometer configured in an input module), blood pressure of the user (e.g., measured using a manometer configured in an input module), skin resistance, skin conductance and stress level of the user (e.g., measured using a galvanic skin sensor configured in an input module), electrical activity of muscles of the user (e.g., measured using an electromyography sensor configured in an input module), glucose level of the user (e.g., continuous glucose monitoring (CGM) sensor configured in an input module), or other biometric and physical parameters of the user 100.

The input controller 104 can use situational or context parameters to select input methods and/or devices. Such parameters can include data about current activity of the user (e.g., whether the user 100 is moving or at rest), the emotional state of the user, the health state of the user, or other situational or context parameters of the user.

The input controller 104 can use environmental parameters to select input methods and/or devices. Such parameters can include ambient temperature (e.g., measured using a thermometer configured in an input module), air pressure (e.g., measured using a barometric sensor), pressure of gases or liquids (e.g., pressure sensor), moisture in the air (e.g., measured using humidity/hygrometer sensor), altitude data (e.g., measured using an altimeter), UV level/brightness (e.g., measured using a UV light sensor or optical module), detection of approaching objects (e.g., detected using capacitive/proximity sensor, optical module, audio module, neural module), current geographical location of the user (e.g., measured using a GPS transceiver, optical module, IMU module), and/or other parameters.

In one embodiment, the sensor manager 103 is configured to: receive input data from at least one motion input module 121 attached to a user and at least one additional input module 131 attached to the user; identify factors representative the state, status, and/or context of the user interacting with an environment, including a virtual environment of a VR/AR/MR/XR display computed in an application 105; and select and/or prioritize one or more methods to identify gesture inputs of the user from the input data received from the input modules (e.g., 121 and/or 131).

For example, the system can determine that the user of the system is located in a well-lighted room and opens a meeting application in VR/AR/MR/XR. The system can set the optical (to collect and analyze video stream while meeting) and audio (to record and analyze audio stream while meeting) input methods as the priority methods to collect the input information.

For example, the system can determine the country/city where a user is located and depending on the geographical, cultural, traditional, position relative to the public places and activities (stores, sports ground, medical/government institutions, etc.) and other conditions which can be determined based on the positional data, the system can set one or more input method or methods as a priority method or methods.

For example, depending on data received from the biosensor components of the input modules 121 or 131 (e.g., temperature, air pressure, humidity, etc.), the system can set one or more input method or methods as a priority method or methods.

For example, a user can do some activities at a certain time of the day (sleep at night, do sport activities at morning, eat at lunch, etc.). Based on the time/brightness input information the system can set one or more input method or methods as a priority method or methods. As an example, if the person is in very weak lighting or in the dark, the input controller 104 does not give a high priority to the camera input (e.g., does not rely on finger tracking using the camera); instead, the input controller 104 can increase the dependency on a touch pad, a force sensor, the recognition of micro-gestures using the inertial measurement units 123, and/or the recognition of voice commands using a microphone.

Input data received from different input modules can be combined to generate input to the application 105.

For example, multiple methods can be used separately to identify the probability of a user having made a gesture; and the probabilities evaluated using the different methods can be combined to determine whether the user has made the gesture.

For example, multiple methods for evaluation an input event can be assigned different weighting factors; and the results of recognizing the input event can be aggregated by the input controller 104 through the weighting factors to generate a result for the application 105.

For example, input data that can be used independent in different methods to recognize an input gesture of a user can be provided to an artificial neural network to generate a single result that combines the clues from the different methods through machine learning.

In one embodiment, the sensor manager 103 is configured to: receive input data from at least one motion input module 121 and at least one additional input module 131, recognize factors that affect the user and their environment at the current moment, determine weights for the results of different methods used to detect a same type of gesture inputs, and recognize a gesture of the type by applying the weights to the recognition results generated from the different methods.

For example, based on sensor data, the system can determine that a user is located outside and actively moving in the rain and with a lot of background noise. The system can decide to give a reduced weight to results from camera and/or microphone data that has elevated environmental noises, and thus a relative high weight to the results generated from inertial measurement units 123. Optionally, the input controller 104 can select a rain noise filter and apply the filter to the audio input for the microphone to generate input.

For example, the sensor manager 103 can determine that due to the poor weather conditions and the fact the user is in motion, it puts less weights on visual inputs/outputs, and so proposes haptic signals and microphone inputs instead of visual based keyboards for navigation and text input.

For example, based on air temperature, heart rate, altitude, speed and type of motion, and snowboarding app running in the background, the sensor manager 103 can determine that the user is snowboarding; and in response, the input controller 104 causes the application 105 to present text data through audio/speaker and uses visual overlays on the AR head mounted display (HMD) for directional information. During this snowboarding period, the sensor manager 103 can give a higher rating to visual (65%) and internal metrics (20%) and auditory (10%) other input methods (5%).

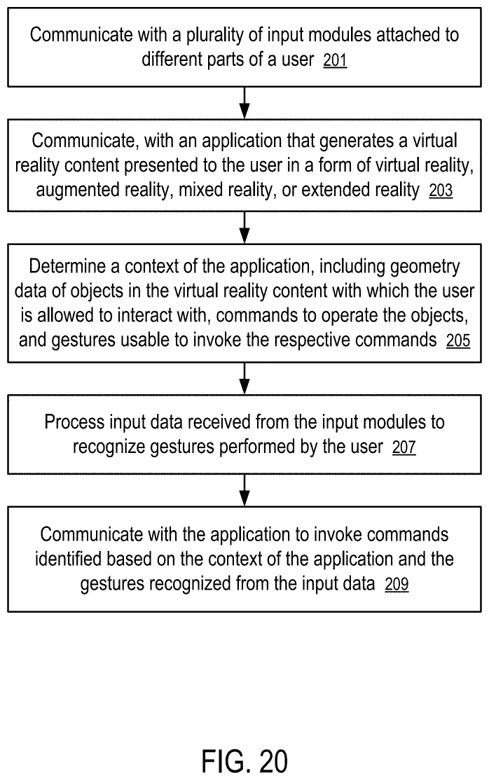

FIG. 20 shows a method to process inputs to control a VR/AR/MR/XR system according to one embodiment.

For example, the method can be implemented in a sensor manager 103 of FIG. 1 or 19 to control a VR/AR/MR/XR application 105, which may run in the same computing device 101, or another device (e.g., 141) or a server system.

At block 201, the sensor manager 103 communicates with a plurality of input modules (e.g., 121, 131) attached to different parts of a user 100. For example, a module input module 121 can be a handheld device and/or a ring device configured to be worn on the middle phalange of an index finger of the user. For example, an addition input module 131 can be a head mounted module with a camera monitoring the eye gaze of the user. The addition input module 131 can be attached to or integrated with a display module 111, such as a head mounted display, or a pair of smart glasses.

At block 203, the sensor manager 103 communicates, with an application 105 that generates a virtual reality content presented to the user 100 in a form of virtual reality, augmented reality, mixed reality, or extended reality.

At block 205, the sensor manager 103 determines a context of the application, including geometry data of objects in the virtual reality content with which the user is allowed to interact with, commands to operate the objects, and gestures usable to invoke the respective commands. The geometry data includes positions and/or orientations of the virtual objects relative to the user to allow the determination of the motion of the user relative to the virtual objects (e.g., whether the eye gaze direction vector 118 of the user points at an object or item in the virtual reality content).

At block 207, the sensor manager 103 processes input data received from the input modules to recognize gestures performed by the user.

At block 209, the sensor manager 103 communicates with the application to invoke commands identified based on the context of the application and the gestures recognized from the input data.

For example, the gestures recognized from the input data can include a gesture of swipe, tap, long tap, press, long press, grab, or pinch.

Optionally, inputs generated by the input modules attached to the user are sufficient to allow the gesture to be detected separately by multiple methods using multiple subsets of inputs; and the sensor manager 103 can select one or more method from the multiple methods to detect the gesture.

For example, the sensor manager 103 can ignore a portion of the inputs not used to detect gesture inputs in the context, or instruct one or more of the input module to pause transmission of a portion of the inputs not used to detect gesture inputs in the context.

Optionally, the sensor manager 103 can determine weights for multiple methods and combine results of gesture detection gesture performed using the multiple methods according to the weights to generate a results of detecting the gesture in the input data.

For example, the multiple methods can include: a first method to detect the gesture based on inputs from the inertial measurement units of the handheld module; a second method to detect the gesture based on inputs from a touch pad, a button, or a force sensor configured on the handheld module; and/or a third method to detect the gesture based on inputs from an optical input device, a camera, or an image sensor configured on a head mounted module. For example, at least one of the multiple methods can be performed and/or selected based on inputs from an optical input device, a camera, an image sensor, a lidar, an audio input device, a microphone, a speaker, a biological response sensor, a neural activity sensor, an electromyography sensor, a photoplethysmography sensor, a galvanic skin sensor, a temperature sensor, a manometer, a continuous glucose monitoring sensor, or a proximity sensor, or any combination thereof.

Input data received from the sensor modules and/or the computing devices discussed above can be optionally used as one of the basic input methods for the sensor management system and further be implemented as a part of the Brain-Computer Interface system.

For example, the sensor management system can operate based on the information received from the IMU, optical, and Electromyography (EMG) input modules and determine weights for each input method depending on internal and external factors while the sensor management system is being used. Such internal and external factors can include quality and accuracy of each data sample received at the current moment, context, weather conditions, etc.

For example, an Electromyography (EMG) input module can generate data about muscular activity of a user and send the data to the computing device 101. The computing device 101 can transform the EMG data to orientational data of the skeletal model of a user. For example, EMG data of activities of muscles on hands, forearms and/or upper arms (e.g., deltoid muscle, triceps brachii, biceps brachii, extensor carpi radialis brevis, extensor digitorium, flexor carpi radialis, extensor carpi ulnaris, adductor pollicis) can be measured using sensor modules and used to correct orientational/positional data received from the IMU module or the optical module, and vice versa. An input method based on EMG data can save the computational resources of the computing device 101 as a less costly way to obtain input information from a user.

As discussed in U.S. patent application Ser. No. 17/008,219, filed Aug. 31, 2020 and entitled “Track User Movements and Biological Responses in Generating Inputs for Computer Systems”, the entire disclosure of which is hereby incorporated herein by reference, the additional input modules 131 and/or the motional input module 121 can include biological response sensors (e.g., 136 and 126), such as Electromyography (EMG) sensors that measure electrical activities of muscles. To increase the accuracy of the tracking system, data received from the Electromyography (EMG) sensors embedded into the motion input modules 121 and/or the additional input module 131 can be used. To provide a better tracking solution, the input modules (e.g., 121, 131) having such biosensors can be attached to the user's body parts (e.g., finger, palm, wrist, forearm, upper arm). Various attachment mechanisms can be used. For example, a sticky surface can be used to attach an EMG sensor to a hand, an arm of the user. For example, EMG sensors can be used to measure the electrical activities of deltoid muscle, triceps brachii, biceps brachii, extensor carpi radialis brevis, extensor digitorium, flexor carpi radialis, extensor carpi ulnaris, and/or adductor pollicis, etc., while the user is interacting with a VR/AR/MR/XR application.

For example, the attachment mechanism and the form-factor of a motion input module 121 having an EMG module (e.g., as a biological response sensor 126) can a wristband, a forearm band, or an upper arm band with or without sticky elements.

The computing device 101, the controlled device 141, and/or a module (e.g., 111, 121, 131) can be implemented using a data processing system.

A typical data processing system may include an inter-connect (e.g., bus and system core logic), which interconnects a microprocessor(s) and memory. The microprocessor is typically coupled to cache memory.

The inter-connect interconnects the microprocessor(s) and the memory together and also interconnects them to input/output (I/O) device(s) via I/O controller(s). I/O devices may include a display device and/or peripheral devices, such as mice, keyboards, modems, network interfaces, printers, scanners, video cameras and other devices known in the art. In one embodiment, when the data processing system is a server system, some of the I/O devices, such as printers, scanners, mice, and/or keyboards, are optional.

The inter-connect can include one or more buses connected to one another through various bridges, controllers and/or adapters. In one embodiment the I/O controllers include a USB (Universal Serial Bus) adapter for controlling USB peripherals, and/or an IEEE-1394 bus adapter for controlling IEEE-1394 peripherals.

The memory may include one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In the present disclosure, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to non-transitory, recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROM), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
communicating with a plurality of input modules attached to different parts of a user;
communicating, with an application that generates a virtual reality content presented to the user in a form of virtual reality, augmented reality, mixed reality, or extended reality;
determining a context of the application, including geometry data of objects in the virtual reality content with which the user is allowed to interact with, commands to operate the objects, and gestures usable to invoke the respective commands;
processing input data received from the input modules to recognize first gestures performed by the user; and
communicating with the application to invoke commands identified based on the context of the application and the first gestures recognized from the input data.

2. The method of claim 1, wherein the input modules include at least one handheld module having inertial measurement units to measure motions of a hand of the user.

3. The method of claim 2, wherein the first gestures recognized from the input data include a gesture of swipe, tap, long tap, press, long press, grab, or pinch.

4. The method of claim 3, wherein inputs generated by the input modules are sufficient to allow the gesture to be detected separately by multiple methods using multiple subsets of inputs; and the method further comprises:
selecting one or more methods from the multiple methods to detect the gesture.

5. The method of claim 4, further comprising:
ignoring a portion of the inputs not used to detect gesture inputs in the context.

6. The method of claim 4, further comprising:
instructing one or more of the input module to pause transmission of a portion of the inputs not used to detect gesture inputs in the context.

7. The method of claim 4, further comprising:
determining weights for the multiple methods; and
combining results of detecting the gesture performed using the multiple methods according to the weights to generate a results of detecting the gesture in the input data.

8. The method of claim 4, wherein a first one of the multiple methods is based on inputs from the inertial measurement units of the handheld module.

9. The method of claim 8, wherein a second one in the multiple methods is based on inputs from a touch pad, a button, or a force sensor configured on the handheld module.

10. The method of claim 9, wherein a third one in the multiple methods is based on inputs from an optical input device, a camera, or an image sensor configured on a head mounted module.

11. The method of claim 10, wherein at least one of the multiple methods is performed or selected based on inputs from an optical input device, a camera, an image sensor, a lidar, an audio input device, a microphone, a speaker, a biological response sensor, a neural activity sensor, an electromyography sensor, a photoplethysmography sensor, a galvanic skin sensor, a temperature sensor, a manometer, a continuous glucose monitoring sensor, or a proximity sensor, or any combination thereof.

12. The method of claim 10, wherein the head mounted module includes a display device to present the virtual reality content.

13. The method of claim 10, wherein the input data includes electromyography data representative of electrical activities of muscles of the user over which the input modules are attached; and the method further includes:
combining the electromyography data and measurements from inertial measurement units of the input modules to identify positions and orientations of the different parts of the user.

14. The method of claim 13, wherein the different parts of the user include a hand, a forearm, and an upper arm; and the muscles include deltoid muscle, triceps brachii, biceps brachii, extensor carpi radialis brevis, extensor digitorium, flexor carpi radialis, extensor carpi ulnaris, or adductor pollicis, or any combination thereof.

15. A system, comprising:
a plurality of input modules attachable to different parts of a user; and
a computing device operable to communicate with the plurality of input modules and configured to:
communicate, with an application that generates a virtual reality content presented to the user in a form of virtual reality, augmented reality, mixed reality, or extended reality;
determine a context of the application, including geometry data of objects in the virtual reality content with which the user is allowed to interact with, commands to operate the objects, and gestures usable to invoke the respective commands;
process input data received from the input modules to recognize first gestures performed by the user; and
communicate with the application to invoke commands identified based on the context of the application and the first gestures recognized from the input data.

16. The system of claim 15, wherein the input modules include at least one handheld module having inertial measurement units to measure motions of a hand of the user; the first gestures recognized from the input data include a gesture of swipe, tap, long tap, press, long press, grab, or pinch; inputs generated by the input modules are sufficient to allow the gesture to be detected separately by multiple methods using multiple subsets of inputs; and the computing device is further configured to:
select one or more methods from the multiple methods to detect the gesture;
ignore a portion of the inputs not used to detect gesture inputs in the context; and
instruct one or more of the input module to pause transmission of a portion of the inputs not used to detect gesture inputs in the context.

17. The system of claim 16, wherein the computing device is further configured to:
determining weights for the multiple methods; and
combining results of detecting the gesture performed using the multiple methods according to the weights to generate a results of detecting the gesture in the input data;
wherein a first one of the multiple methods is based on inputs from the inertial measurement units of the handheld module;
wherein a second one in the multiple methods is based on inputs from a touch pad, a button, or a force sensor configured on the handheld module; and
wherein a third one in the multiple methods is based on inputs from an optical input device, a camera, or an image sensor configured on a head mounted module.

18. The system of claim 17, wherein the input data includes electromyography data representative of electrical activities of muscles of the user over which the input modules are attached; and the computing device is further configured to:
combine the electromyography data and measurements from inertial measurement units of the input modules to identify positions and orientations of the different parts of the user;
wherein the different parts of the user include a hand, a forearm, and an upper arm; and the muscles include deltoid muscle, triceps brachii, biceps brachii, extensor carpi radialis brevis, extensor digitorium, flexor carpi radialis, extensor carpi ulnaris, or adductor pollicis, or any combination thereof.

19. A non-transitory computer storage medium storing instructions which, when executed on a computing system, cause the computing system to perform a method, comprising:
communicating with a plurality of input modules attached to different parts of a user
communicating with an application that generates a virtual reality content presented to the user in a form of virtual reality, augmented reality, mixed reality, or extended reality;
determining a context of the application, including geometry data of objects in the virtual reality content with which the user is allowed to interact with, commands to operate the objects, and gestures usable to invoke the respective commands;
processing input data received from the input modules to recognize first gestures performed by the user; and
communicating with the application to invoke commands identified based on the context of the application and the first gestures recognized from the input data.

20. The non-transitory computer storage medium of claim 19, wherein the input modules include at least one handheld module having inertial measurement units to measure motions of a hand of the user; the first gestures recognized from the input data include a gesture of swipe, tap, long tap, press, long press, grab, or pinch; inputs generated by the input modules are sufficient to allow the gesture to be detected separately by multiple methods using multiple subsets of inputs; and
the method further comprises:
selecting one or more methods from the multiple methods to detect the gesture;
ignoring a portion of the inputs not used to detect gesture inputs in the context; and
instructing one or more of the input module to pause transmission of a portion of the inputs not used to detect gesture inputs in the context.
